(19) United States
(12) Patent Application Publication
(10) Pub. No.: US 2013/0076213 A1
(43) Pub. Date: Mar. 28, 2013

(54) ADJUSTABLE CEILING FAN MOTOR SHAFT

(71) Applicants: Kareema A. McCloud, Cordova, TN (US); Brian H. Friedman, Collierville, TN (US); Alan C. Webb, Olive Branch, MS (US)

(72) Inventors: Kareema A. McCloud, Cordova, TN (US); Brian H. Friedman, Collierville, TN (US); Alan C. Webb, Olive Branch, MS (US)

(21) Appl. No.: 13/245,027

(22) Filed: Sep. 26, 2011

(51) Int. Cl. H02K 7/14; H01R 43/00

(52) U.S. Cl. 310/75 D; 29/825

(57) ABSTRACT

A ceiling fan motor (10) is disclosed which is coupled to a motor adapter (11) which in turn is coupled to a downrod (12) and motor housing (13). The ceiling fan motor has a stationary stator (17) and a rotor (18). A motor shaft (20) is coupled to the stator. The motor shaft has an upper portion (23), a middle portion (24), and a lower portion (25). The shaft upper portion has a helical thread (28) and five C-clip spaces (29) which are longitudinally spaced from each other. A C-clip (31) is fitted into one of the five C-clip spaces. The C-clip is configured to abut the bottom surface (32) of the motor adapter to limit the downward movement and position of the motor adapter upon the motor shaft.

### TECHNICAL FIELD

This invention relates to ceiling fans and particularly to the motor shaft of a ceiling fan motor.

### BACKGROUND OF THE INVENTION

Most ceiling fans are electrically powered. Typically they comprise an electric motor that is suspended beneath a ceiling by a hollow downrod through which electrical wires extend from building line power to the motor. An annular array of fan blades is mounted about the motor rotor by means of blade irons.

Ceiling fans sometime use an inside-out motor to cause rotation of the blade irons. These inside-out motors have a rotor rotatably mounted about the stationary stator. With these inside-out motors a motor shaft extending from the stator is coupled to the downrod through a motor adapter. The motor adapter is also coupled to the exterior, ornamental motor housing surrounding the motor. However, with each design of the motor and the surrounding motor housing the spacing between these components may vary. As such, each ceiling fan design may incorporate a different motor shaft length. The design and manufacture of different motor shafts increases the overall costs associated with ceiling fans and causes problems in keeping a proper inventory of all motors of varying shaft lengths.

Accordingly, it is seen that a need remains for a ceiling fan motor that can accommodate different designs of motor housings. It is to the provision of such therefore that the present invention is primarily directed.

### SUMMARY OF THE INVENTION

A ceiling fan motor comprises a stationary stator, a rotor mounted for rotary movement about the stator, and a motor shaft coupled to the stator. The motor shaft has an upper portion extending outwardly from the stator with a plurality of clip mounting slots therein. The motor shaft also has a clip configured to be mounted to one slot of the plurality of slots. The ceiling fan also includes a motor adapter configured to receive the motor shaft, abut the motor shaft clip, and be coupled to a motor housing.

In another form of the invention a method of manufacturing a ceiling fan comprises the steps of providing an electric motor having a motor shaft with a plurality of clip channels and a clip configured to be received within a clip channel, providing a motor adapted configured to mate with the motor shaft, providing a motor housing adapted to mate with the motor adapter, selecting a clip channel from the plurality of clip channels to provide a proper spacing between the motor and the motor housing, positioning the clip within the selected clip channel, mounting the motor adapter to the motor shaft in a position to abut the clip, and coupling the motor housing to the motor adapter.

### BRIEF DESCRIPTION OF THE DRAWING

FIG. 1 is a perspective view of a portion of a ceiling fan embodying principles of the invention in a preferred form.

FIG. 2 is a perspective view of a motor shaft of the ceiling fan of FIG. 1.

FIG. 3 is a side view of a motor shaft of the ceiling fan of FIG. 1.

FIG. 4 is a partial cross-sectional view of a portion of the ceiling fan of FIG. 1.

FIG. 5 is a side view of a portion of the ceiling fan of FIG. 1, shown with a motor housing adapter in a first position.

FIG. 6 is a side view of a portion of the ceiling fan of FIG. 1, shown with a motor housing adapter in a second position.

FIG. 7 is a side view a portion of the ceiling fan of FIG. 1, shown with a motor housing adapter in a third position.

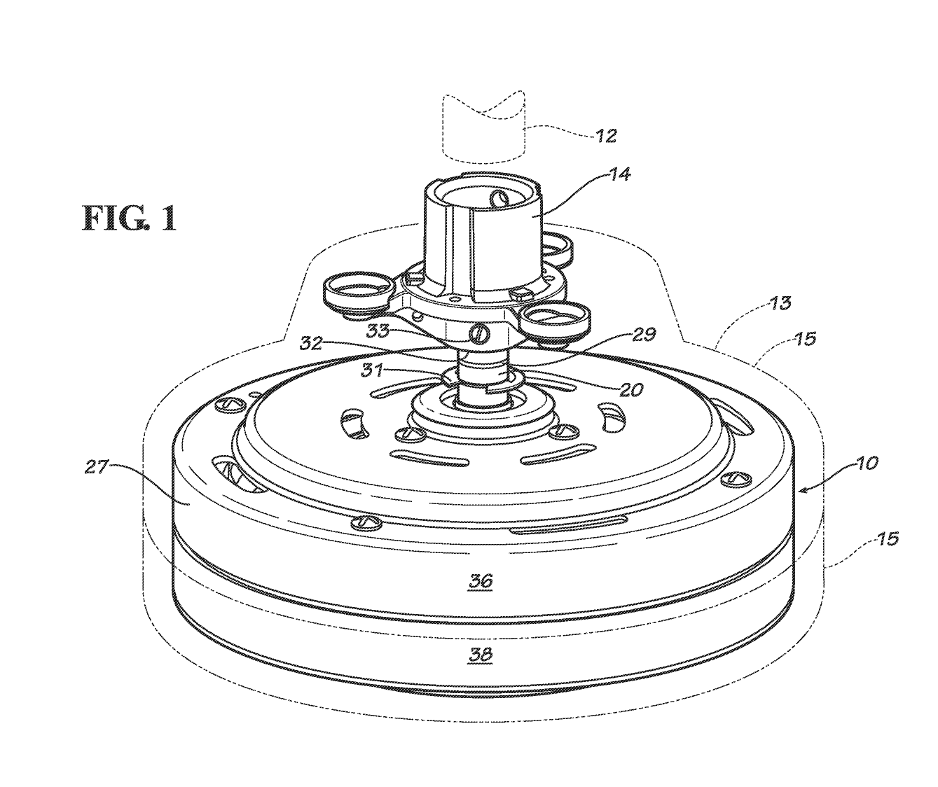

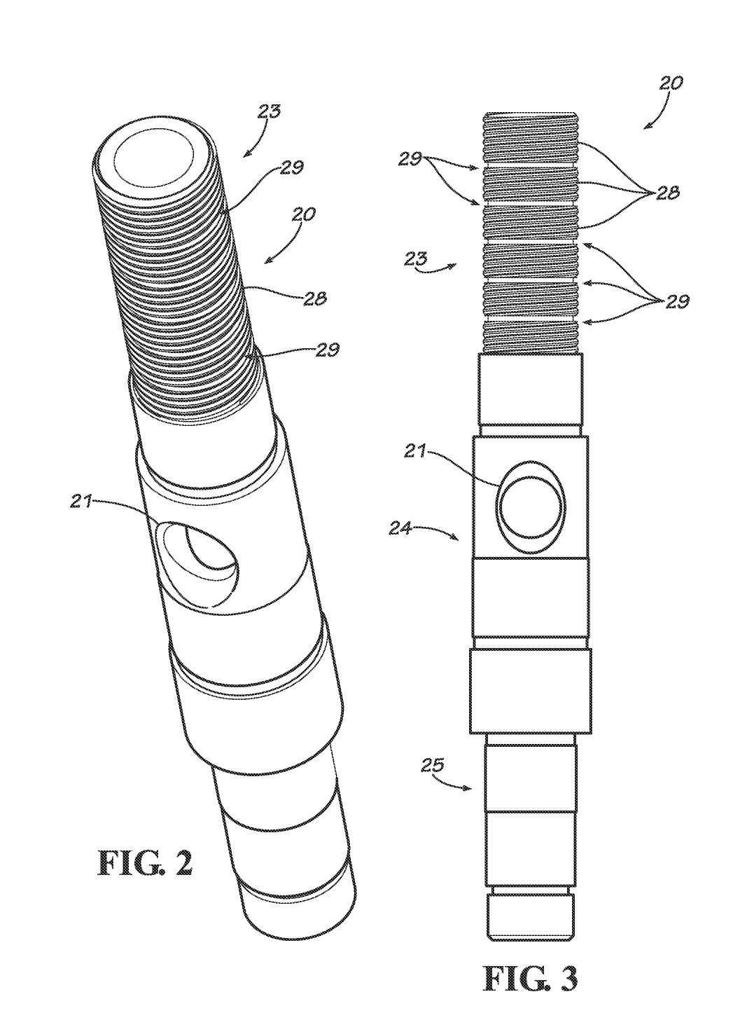

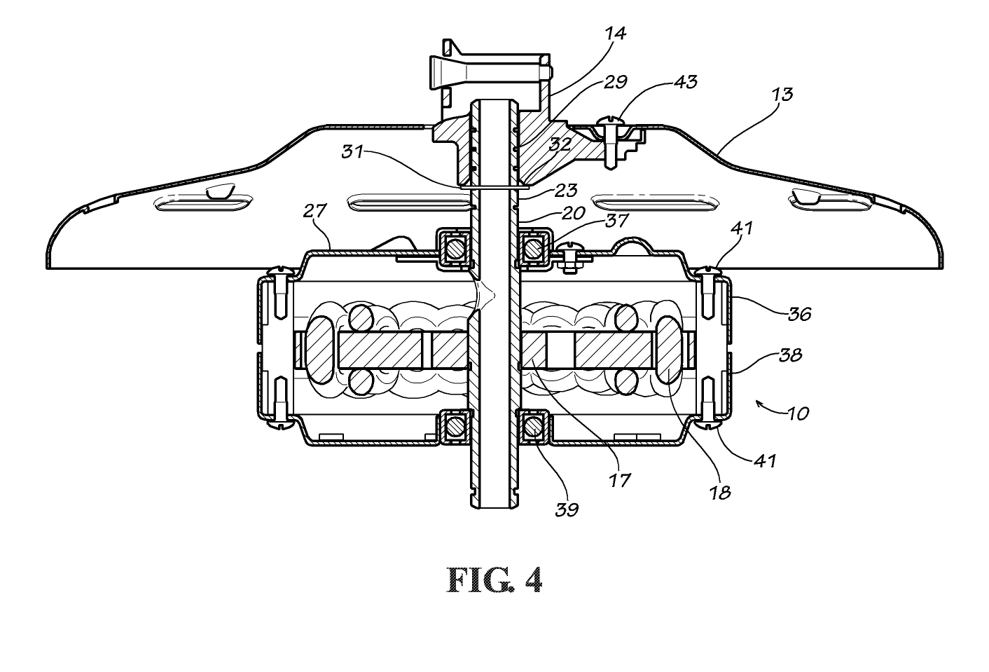

### DETAILED DESCRIPTION

With reference next to the drawings, there is shown a ceiling fan motor 10 embodying principles of the invention in a preferred form. The ceiling fan motor 10 is shown coupled to a motor adapter 11 having a downrod 12 coupled to an upper end thereof. The motor adapter 11 is also shown coupled to a top portion of an ornamental motor housing 13. The motor housing 13 has an upper portion 15 and lower portion 16 which in combination substantially surround and encase the motor.

The ceiling fan motor 10 is of an inside-out design having a centrally mounted stationary stator 17 and a rotor 18 surrounding and rotating about the stationary stator 17. The motor 10 includes a centrally mounted elongated motor shaft 20 which is coupled to the stator 17 in conventional fashion. The motor shaft 20 is tubular and includes a wire passage hole 21 through which the electrical wires of the motor may pass.

The motor shaft 20 has an upper portion 23, a middle portion 24, and a lower portion 25. The middle portion 24 includes the wire passage hole 21 and is coupled to the stator 17 and to the rotor 18 through a motor casing 27, as described in more detail hereinafter. The shaft upper portion 23 extends above the motor casing 27 and has a helical thread 28 and five C-clip channel or spaces 29 which are longitudinally spaced from each other. A C-clip 31 is fitted into one of the five C-clip spaces 29. The C-clip 31 is configured to abut the bottom surface 32 of the motor adapter 14 to limit the downward movement and position of the motor adapter 14 upon the motor shaft 20 during assembly. The motor adapter 14 includes a set screw 33 which may be threaded into abutment with the motor shaft 20 to fix the position of the motor adapter 14 upon the shaft. The shaft lower portion 25 extends downwardly beyond the motor casing 27.

The motor stator 17 is press fitted onto a mid-section of the middle portion 24 of the motor shaft 20. The motor casing 27 includes a top plate 36 having a top bearing 37 which is press fitted onto an upper-section of the middle portion 24 of the motor shaft 20. The motor casing 27 also has a bottom plate 38 having a bottom bearing 39 which is press fitted onto a lower-section of the middle portion 24 of the motor shaft 20. The upper and lower bearings allow the motor casing 19 and therefore the rotor to rotate about the shaft 20. The motor casing 27 is coupled to the rotor 18 through mounting screws 41 to maintain the position of the rotor 18 relative to the stator 17.

The motor adapter 14 has a central, tubular downrod receiver or hub 45, a tubular motor shaft receiver or hub 46, and three mounting arms 47 extending radially from the downrod receiver 45. Each arm 47 has a recessed well 48 which is configured to receive a resilient spacer or washer 49. The motor shaft receiver 46 includes internal threads 50 which are configured to mesh or mate with the external threads 28 of the motor shaft.

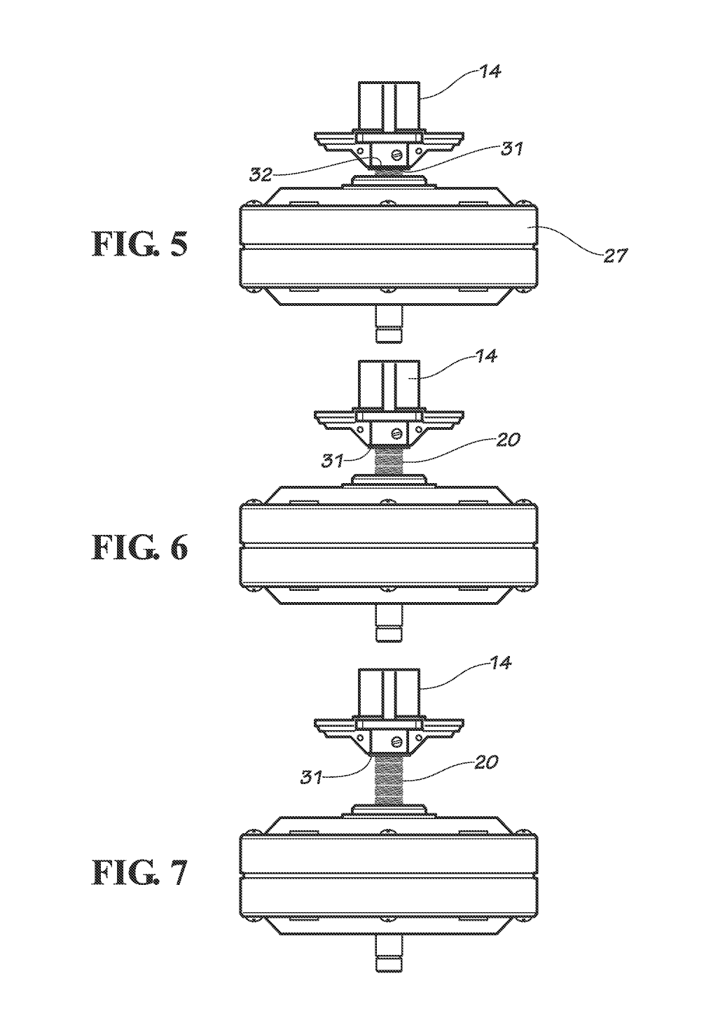

In use, during the manufacturing process of assembling the ceiling fan the manufacturer determines the proper height which the motor adapter 14 should be set relative to the remaining portions of the motor and the sizing (height) of the motor housing 13. Once the proper longitudinal position of the motor adapter 14 is determined the manufacturer simply places the C-clip 31 into the appropriate approximate C-clip space 29 which positions the motor adapter 14 in the proper position where the motor adapter 14 threadably comes to rest upon or abuts the C-clip 31 so that the motor housing is properly positioned relative to the motor. For example, if the motor housing 13 has a low profile or shallow height the C-clip 31 may be positioned at the lowermost C-clip space 29 so that the motor adapter 14 is threaded to a position relatively close to the underlying motor casing 27, as shown in FIG. 5. On the other hand, if the motor housing 13 has a high profile or tall height the C-clip 31 may be positioned at the upper-most C-clip space 29 so that the motor adapter 14 is threaded to a position relatively far away from the underlying motor casing 27, as shown in FIG. 7. A motor housing 13 having a middle profile so that the C-clip is selectively positioned within one of the middle C-clip spaces 29 is shown in FIG. 6 for comparison purposes.

As such, the selection and positioning of the C-clip 31 within one of the five pre-selected C-clip spaces 29 determines the relative positioning of the motor adapter 14 and consequentially the motor housing 13. This allows a manufacturer a great amount of leeway in utilizing the same motor in many different designs or different motor housing heights, configurations, or relative positions, as opposed to having to customize each motor shaft for the particular fan in which it is utilized.

Once the motor adapter 14 is threaded into positioned upon the threaded upper portion 23 of the motor shaft 20 and longitudinally abutted against the C-clip 31 the position of the motor adapter 14 is fixed through the fastening of a set screw 33. The motor housing upper portion 15 is then lowered onto the motor adapter 14 and mounted in place through mounting screws 43 extending through the motor housing upper portion 15 and into the motor adapter 14. The lower portion 16 of the motor housing is then raised and joined to the upper portion 15 through mounting screws. The downrod 12 is typically coupled to the motor adapter 14 at the time of installing the fan to the ceiling.

It should be understood that the preferred embodiment shows the use of five pre-selected C-clip spaces 29, however, this is for illustrative purposes only as the number of C-clip spaces may vary depending upon how much flexibility is desired, the more spaces allow for more flexibility in the number of heights a manufacturer may select. It should also be understood that as an alternative to the C-clip of the preferred embodiment the motor may include other types of stop means to limit the position of the motor adapter, such as other types of stop means may include, but is not limited to, clips, fasteners, stop pins, etc.

It should be understood that the orientation terms used herein, such as upwardly and downwardly, are used for illustrative purposes only.

It thus is seen that a ceiling fan motor shaft is now provided which overcomes problems associated with ceiling fan motors of the prior art. While this invention has been described in detail with particular references to the preferred embodiments thereof, it should be understood that many modifications, additions and deletions, in addition to those expressly recited, may be made thereto without departure from the spirit and scope of the invention.

1. A ceiling fan motor comprising,
a stationary stator;
a rotor mounted for rotary movement about said stator;
a motor shaft coupled to said stator, said motor shaft having an upper portion extending outwardly from said stator with a plurality of clip mounting slots, said motor shaft also having a clip configured to be mounted to one said slot of said plurality of slots, and
a motor adapter configured to receive said motor shaft and abut said motor shaft clip and be coupled to a motor housing.

2. The ceiling fan motor of claim 1 wherein said motor shaft upper portion contains external helical threads, and wherein said motor adapter includes internal helical threads configured to mate with said motor shaft upper portion helical threads.

3. The ceiling fan motor of claim 2 wherein said clip is a C-shaped clip.

4. The ceiling fan motor of claim 1 wherein said clip is a C-shaped clip.

5. The ceiling fan motor of claim 1 further comprising a motor housing coupled to said motor adapter.

6. A motor shaft for use with an electric motor having a stationary stator, a rotating rotor, and a motor housing adapter, the motor shaft comprising a middle portion configured to be coupled to the stator of the electric motor, a lower portion extending from said middle portion and adapted to extend downwardly and outwardly from the stator of the electric motor, and an upper portion extending from said middle portion and adapted to extend upwardly and outwardly from the stator of the electric motor and be received within the motor housing adapter, said upper portion having at least two clip channels and a clip configured to be received within one said clip channel and to abut the motor housing adapter coupled to said motor shaft.

7. The motor shaft of claim 6 wherein said motor shaft upper portion contains external helical threads that are adapted to mate with internal helical threads within the motor housing adapter.

8. The motor shaft of claim 7 wherein said clip is a C-shaped clip.

9. The motor shaft of claim 6 wherein said clip is a C-shaped clip.

10. A ceiling fan motor comprising,
a stationary stator;
a rotor mounted for rotary movement about said stator;
a motor shaft coupled to said stator, said motor shaft having an upper portion extending outwardly from said stator;
a motor adapter configured to be received upon said motor shaft, and
adjustable stop means for limiting the position of said motor adapter along said motor shaft, said stop means including a stop configured to be coupled to said motor shaft at a plurality of pre-selected longitudinal positions along said motor shaft.

11. The ceiling fan motor of claim 10 wherein said stop means includes a plurality of stop clip mounting slots and a clip configured to be mounted to one said slot of said plurality of slots.

12. The ceiling fan motor of claim 10 wherein said motor shaft upper portion contains external helical threads, and wherein said motor adapter includes internal helical threads configured to mate with said motor shaft upper portion helical threads.

13. The ceiling fan motor of claim 12 wherein said clip is a C-shaped clip.

14. The ceiling fan motor of claim 11 wherein said clip is a C-shaped clip.

15. The ceiling fan motor of claim 10 further comprising a motor housing coupled to said motor adapter.

16. A method of manufacturing a ceiling fan comprising the steps of:
(A) providing an electric motor having a motor shaft with a plurality of clip channels and a clip configured to be received within a clip channel;
(B) providing a motor adapted configured to mate with the motor shaft;
(C) providing a motor housing adapted to mate with the motor adapter;
(D) selecting a clip channel from the plurality of clip channels to provide a proper spacing between the motor and the motor housing;
(E) positioning the clip within the selected clip channel;
(F) mounting the motor adapter to the motor shaft in a position to abut the clip, and
(G) coupling the motor housing to the motor adapter.

17. The method of claim 16 wherein step (F) the motor adapter is threaded to the motor shaft.

18. The method of claim 17 wherein the clip is a C-shaped clip.

19. The method of claim 16 wherein said clip is a C-shaped clip.
